(19) United States
(12) Patent Application Publication
(10) Pub. No.: US 2004/0175661 A1
(43) Pub. Date: Sep. 9, 2004

(54) Granular solid photographic processing agent and production method thereof

(76) Inventor: Hideaki Nomura, Minami-Ashigara-shi (JP)

Correspondence Address: BIRCH STEWART KOLASCH & BIRCH, PO BOX 747, FALLS CHURCH, VA, 22040-0747, US

(21) Appl. No.: 10/788,367

(22) Filed: Mar. 1, 2004

(30) Foreign Application Priority Data
Mar. 3, 2003 (JP) 2003-055911

(51) Int. Cl. G03C 5/38

(52) U.S. Cl. 430/458; 430/455

(57) ABSTRACT

In order to provide a granular solid processing agent capable of avoiding consolidation among its constituent granules even when the granules sustain some damage by vibrations during transportation or/and are placed under high humidity conditions, and thereby maintaining qualities in the solid processing agent, and a method of producing such a granular solid processing agent, disclosed are solid processing agents for silver halide photosensitive materials, which each have granules containing an organic acid whose ammonium salt has a critical relative humidity of at least 70% RH, particularly the solid processing agents for silver halide photosensitive materials whose granules are core-shell granules containing the organic acids in their individual shell layers.

### BACKGROUND OF THE INVENTION

1. Field of the Invention

The present invention relates to a photographic processing agent (referred simply to as a processing agent, hereinafter) for silver halide photosensitive materials (also referred to as light-sensitive materials, hereinafter) and, more particularly, to a granular solid processing agent and a method of producing the same.

2. Background Art

Recent years have seen widespread use of automatic processors called “mini labs” which are installed in the fronts of camera shops and perform processing of photosensitive materials, because mini labs can offer speedy services to end users and rationalization of collection-and-delivery and transportation to and from photo laboratories. Hitherto, concentrated prepared liquid processing chemicals have been supplied to mini labs, but they have problems arising because of a liquid state in which they are, including regulations on transportation, danger from vessel breakage by shock, inconvenience of handling liquids in photofinishing laboratories and space constraints on storage. With the intention of solving these problems, solid processing agents including the granular processing agent (disclosed in Patent Document 1) and methods of processing by direct addition of solid processing agents to processing tanks (as disclosed in Patent Document 2) have been studied. According to such methods, it is possible to supply processing agents in a solid state. However, it has turned out that, when the processing agents are stored under aging, new problems come up that the solid processing agents take upmoisture to result in loss of their stability, and further stick together, or cause the so-called consolidation phenomenon. When the method of adding solid processing agents directly to the processing tanks is carried out using solid processing agents containing highly hygroscopic alkali metal hydroxides or thiosulfates in particular, the solid processing agents cause consolidation upon storage in settings of a photofinishing laboratory and during standby in a high humidity condition inside a processor prior to being added and interfere with processing operations, and at the same time they have detrimental effects on finished photograph qualities.

For the purpose of preventing solid processing agents from causing consolidation by aging, the method of homogeneously mixing an alkyl-substituted hydroxylamine-containing composition and an alkali metal hydroxide is disclosed in Patent Document 3, and the granular and tabular agents having multilayer structures are disclosed in Patent Documents 4 and 5, respectively. However, the effects produced thereby are insufficient under high humidity conditions, and those disclosures are not very acceptable solutions of the problems mentioned above.

Therefore, Patent Document 6 proposes the granular solid processing agent having a core-shell structure in which constituents having critical relative humidity of 70% or below are incorporated in each inner core (core) and the core surface is covered with a coating layer (shell) of other constituents having critical relative humidity higher than 70%. This core-shell granular solid processing agent shows a noticeable improvement in consolidation under aging, but fails to achieve sufficient effects under high humidity circumstances of a photofinishing laboratory, particularly those of a processing site. As a method of making improvement thereon, Patent Document 7 discloses the method of preventing consolidation by coating the granule surface with a silicone compound. The solid processing agent provided with such a coating layer, though has an improvement in the effect of preventing the consolidation attributed to aging upon storage, is still insufficient to prevent the consolidation under high humidity conditions which is supposed to be caused by granules' being fractured (e.g., the shell layer's being broken) by vibrations during transportation and handling.

The following are documents relating to the background arts of the present invention:

Patent Document 1: JP-A-2-109042

Patent Document 2: JP-A-2-109042

Patent Document 3: JP-A-6-123947

Patent Document 4: JP-A-5-93991

Patent Document 5: JP-A-5-134362

Patent Document 6: JP-A-2001-183780

Patent Document 7: JP-A-2002-19645.6

### SUMMARY OF THE INVENTION

Therefore, the invention has been made to solve the foregoing problems associated with the stability of a granular solid processing agent during not only storage attended by aging under high humidity circumstances, but also transportation and handling. More specifically, an object of the invention is to provide a granular solid processing agent which can avoid causing consolidation among its constituent granules even when the granules sustain some damage by vibrations during transportation or/and they are placed under high humidity conditions, and thereby can maintain qualities in the solid processing agent. And another object of the invention is to provide a method of producing such a granular solid processing agent.

The above objects are attained by embodiments of the invention as described below:

(1) A solid processing agent for silver halide photosensitive materials, characterized by having granules containing an organic acid whose ammonium salt has a critical relative humidity of at least 70% RH.

(2) A granular solid processing agent for silver halide photosensitive materials as described in (1), characterized by being used in a processing solution having a fixing capability.

(3) A granular solid processing agent for silver halide photosensitive materials as described in (1) or (2), characterized in that the granules are granules having a core-shell structure.

(4) A granular solid processing agent for silver halide photosensitive materials as described in (3), characterized in that the granules having a core-shell structure contain a thiosulfate as a main component of the core.

(5) A granular solid processing agent for silver halide photosensitive materials as described in (3) or (4), characterized in that the organic acid whose ammonium salt has a critical relative humidity of at least 70% RH at 32° C. is contained in at least one shell layer.

(6) A granular solid processing agent for silver halide photosensitive materials as described in any of (1) to (5), wherein the organic acid whose ammonium salt has a critical relative humidity of at least 70% RH at 32° C. is an acid selected from the group consisting of 3-12C alkylcarboxylic acids, 5-12C alkylenedicarboxylic acids, 4-12C alkenylenedicarboxylic acids, phenylenedicarboxylic acids, aminopolycarboxylic acids and phenylmonocarboxylic acids.

(7) A granular solid processing agent for silver halide photosensitive materials as described in (0.6), characterized in that the organic acid whose ammonium salt has a critical relative humidity of at least 70% RH is an acid selected from the group consisting of ethylenediaminetetraacetic acid, iminodiacetic acid, maleic acid, phenylenedicarboxylic acid and benzoic acid.

(8) A granular solid processing agent for silver halide photosensitive materials as described in (3) to (7), characterized in that the organic acids whose ammonium salts have critical relative humidity values of at least 70% RH at 32° C. constitute 100% of organic acids contained in the processing agent.

(9) A granular solid processing agent for silver halide photosensitive materials as described in (3) to (8), characterized in that the organic acid which is contained in the processing agent and has an at least 70% RH of critical relative humidity at 32° C. when forms an ammonium salt has in itself also an at least 70% RH of critical relative humidity.

(10) A method of producing a granular solid processing agent for silver halide photosensitive materials as described in any of (1) to (9), characterized by having a step of incorporating in the granules the organic acid whose ammonium salt has a critical relative humidity of at least 70% RH at 32° C.

(11). A method of producing a solid processing agent as described in (10) characterized in that the solid processing agent produced is a core-shell granular processing agent having a core and at least one shell layer covering the core, wherein core having a critical relative humidity of 70% RH or lower at 32° C. are formed by granulation and then at least one coating layer containing the organic acid whose ammonium salt has a critical relative humidity of 70% RH or higher is provided on the surface of the core.

A feature of the invention consists in using an organic acid whose ammonium salt has a critical relative humidity of at least 70% RH as a constituent of granules of a granular solid processing agent. Incorporation of such an organic acid in granules can prevent the granules from consolidating even when they are aged under high humidity circumstances, and besides, its effect, of preventing consolidation can be maintained even when the granules sustain some damage by vibrations during transportation and handling; as a result, the granules can maintain qualities needed in a solid processing agent.

The invention can fully achieve its effects in a case where the present solid processing agent is a solid processing agent having a fixing capability, such as a solid processing agent used in a bleach-fix bath or a fixing bath, especially in the case where the solid processing agent contains a thiosulfate as the ammonium salt.

The effects of the invention are remarkably produced when the solid processing agent takes the form of granules having a core-shell structure, especially when the granules have a makeup that an organic acid having the foregoing property is incorporated in a shell layer. Herein, the organic acid may be a single constituent or one of mixed constituents of the shell layer.

By giving the makeup of each granule a composite structure built up of a core made from a hygroscopic constituent and a coating layer made from other constituents, absorption of moisture and consolidation in storage and handling environments can be prevented. Therefore, it is effective to configure a core-shell granular processing agent so that, in the case of a color developing agent, alkali metal hydroxides as deliquescent components are incorporated in each core, while in the case of a processing agent having a fixing capability thiosulfates having relatively high hygroscopicity, particularly ammonium thiosulfate, are incorporated in each core. The core of the present invention preferably contains a thioslfate in an amount of 50 to 100 weight %, more preferably 80 to 100 weight %.

The effects of the invention are effects which become manifest when an organic acid used in the invention is at least 70% RH in critical relative humidity as its ammonium salt, and are not detectable in the case of using an organic acid lower than 70% RH in the aforesaid humidity.

The organic acids used as those which can produce the effects characterizing the invention may be any of organic acids as far as they meet a requirement that their ammonium salts are at least 70% RH in critical relative humidity, and besides, they are soluble in processing solutions, can be present together with other constituents of a processing agent in which they are incorporated and have no adverse effects on photographic properties. While the mechanism by which the organic acids meeting such requirements prevent solidification of processing agents and enhance their stability is not clarified yet, we suppose that the organic acids undergo partial metathesis reaction with hygroscopic salts, such as ammonium salts, constituting a processing agent and thereby the hygroscopicity control is effected.

Additionally, the temperature at which all the critical relative humidity values in the invention are determined is 32° C. unless otherwise specified. The critical relative humidity value can be obtained by determining a moisture absorption-release equilibrium curve at 32° C.

### DETAILED DESCRIPTION OF THE INVENTION

Embodiments of the invention are described below in detail.

To begin with, organic acids which have critical relative humidity values of at least 70% RH when form the ammonium salts and produce the effects characterizing the invention are illustrated.

As mentioned above, the organic acid(s) used in the invention may be any of organic acids as far as they meet a requirement that their ammonium salts are at least 70% RH in critical relative humidity, and besides, they are soluble in processing solutions, can be present together with other constituents of a processing agent in which they are incorporated and have no adverse effects on photographic properties.

Of such organic acids, carboxylic acids are used to advantage. More specifically, it is preferable to use 3-12C alkylcarboxylic acids, 5-12C alkylenedicarboxylic acids, 5-12C alkenylenedicarboxylic acids, phenylenedicarboxylic acids, aminopolycarboxylic acids and phenylmonocarboxylic acids. These carboxylic acids may be substituted with 1-3C alkyl groups or halogen atoms.

Examples of organic acids usable in the invention are illustrated below, but the compounds relating to the invention should not be construed as being limited to these examples.

Examples of an alkylcarboxylic acid containing 3 to 12 carbon atoms include propionic acid, butyric acid, valerianic acid, isovalerianic acid and pivalic acid.

Examples of an alkylenedicarboxylic acid containing 5 to 12 carbon atoms include glutaric acid, adipic acid and pimelic acid.

Examples of an alkenylenedicarboxylic acid containing 5 to 12 carbon atoms include maleic acid, 1-butenoic acid and 2-butenoic acid.

Examples of a phenyldicarboxylic acid include o-phthalic acid, m-phthalic acid and terephthalic acid.

Examples of an aminopolycarboxylic acid include polyaminopolycarboxylic acids, such as diethylenetriaminepentaacetic acid, ethylenediaminetetraacetic acid, transcyclohexanediaminetetraacetic acid, 1,2-diaminopropanetetraacetic acid, glycoletherdiaminetetraacetic acid, ethylenediaminedisuccinic acid (SS body), N,N′-bis(2-hydroxybenzyl)ethylenediamine-N,N′-diacet ic acid and 1,4-cyclohexanediaminetetraacetic acid; and monoaminopolycarboxylic acids, such as methylaminodiacetic acid, nitrilotriethylenecarboxylic acid, N-(2-carboxylatoethyl)-L-aspartic acid β-alaninediacetic acid and hydroxyethylaminodiacetic acid.

Examples of a phenylmonocarboxylic acid include benzoic acid, 2-methylbenzoic acid and catechol-4-carboxylic acid.

Of these organic acids, ethylenediaminetetraacetic acid, iminodiacetic acid, maleic acid, phenylenedicarboxylic acids and benzoic acid in particular are prefered over the others. The following are critical relative humidity values of the organic acids preferred in particular and those of their ammonium salts.

### Critical Relative Humidity Values of

Organic Acids and their Ammonium Salts

| | |
|---|---|
| | Ammonium salt |
| Organic acid | of organic acid |

| | | | | |
|---|---|---|---|---|
| Ethylenediamine- | 87% | RH | 78% | RH |
| Tetraacetic acid | | | | |
| Maleic acid | 84% | RH | 80% | RH |
| Terephthalic acid | 86% | RH | 73% | RH |
| m-Phthalic acid | 88% | RH | 74% | RH |
| Phthalic acid | 86% | RH | 74% | RH |
| Benzoic acid | 87% | RH | 87% | RH |

In general, the organic acids usable in the present granular solid processing agent have critical relative humidity values of at least 70% RH not only in the form of their ammonium salts but also in themselves.

As to the proportion of organic acid(s) in granules, the organic acids make up 2-50% by weight, preferably 5-40%, of the total granules by mass. When the granules have a core-shell structure, the amount of the organic acid(s) in the shell layer(s) is preferably 20 to 100%, more preferably 30 to 100% by weight based on the total amount of the shell layer(s).

These organic acids can also produce their effects when they, together with other constituents, are incorporated in granules of a single composition (or granules uniform throughout in composition), and it goes without saying that they may be incorporated in granules having a core-shell structure. In the case of incorporating the organic acids into granules having a core-shell structure, it's all right to incorporate constituents hygroscopic compared with other constituents into the core, or the core, of each granule, and to incorporate the organic acids alone or together with other constituents into the shell of each granule. When the shell is formed of two or more layers, the effects can be recognized regardless of whether the layer into which the organic acids are incorporated is an inner layer or an outer layer, but the incorporation into an outer layer enables enhancement of the effects.

The organic acids may be used together as a mixture of two or more thereof, or they may be divided among different parts (e.g., the outermost and inner shell layers and the core of each granule) and used therein, respectively.

Most of the constituents comparatively high in hygroscopicity which are suitably allotted to the core layer(s) in granules of a core-shell structure are ingredients having critical relative humidity values of 70% RH or below. Examples of such an ingredient in the case of the granular processing agent for a color developer include alkali metal hydroxides, potassium carbonate, hydroxylamine sulfate and potassium sulfite, and those in the case of the granular processing agent for a processing solution having a fixing capability include ammonium salts, such as ammonium thiosulfate, ammonium nitrate, ammonium sulfite. When the core is 70% RH or below in critical relative humidity, the hygroscopicity is high, so the present method becomes more effective. And, from the practical viewpoint, it is appropriate that the critical relative humidity of the core be 50%. RH or above.

In the case of the core containing alkali metal hydroxides, the present effects become pronounced when the alkali metal hydroxide is lithium hydroxide. In the case where the core is thiosulfate(s), the present effects are great when the thiosulfates are ammonium thiosulfate and sodium thiosulfate, and they are outstanding when the thiosulfate is ammonium thiosulfate. In addition, the present effects become great when each core contains an ingredient having a critical relative humidity of 70% RH or below in a proportion of at least 50% by mass, and when the proportion of such an ingredient is from 60% to 100% by mass, the present effects become especially pronounced.

The structure of the present granules, which is made up of a core and a layer or layers covering the core, is a structure referred generally to as a core-shell structure. Therein, the shell may be a multiple layer made up of two or more layers. In this case, the constituents can be divided among the layers so as to ensure their stabilities. The present granules each have a core whose surface is covered with at least one coating layer, preferably two to ten coating layers, far preferably two to five coating layers. These coating layers are each composed of an organic acid as recited above (which is required to be incorporated in at least one of the coating layers) and other constituents of a processing agent (which are mentioned hereinafter), exclusive of alkali metal hydroxides and thiosulfates in particular. In addition to the constituents of a processing agent, substances inactive in development, such as inorganic salts and water-soluble polymers, can further be added from binding-property, stability and mechanical-strength viewpoints. In the invention, it is preferable that the critical relative humidity of the coating layers as the shell is higher than that of the core. And it is far preferable that the critical relative humidity of the coating layers is 70% RH or above. Moreover, it is suitable for the present coating layers to have the total mass greater than that of the core by a factor of at least 0.5, preferably at least 0.8, particularly preferably at least 1.0.

In dividing constituents of a granular processing agent between constituents for the inner core (or core) and those for the coating layers (or shell), the constituents are divided into two composition groups (1) and (2) according to known chemical findings, wherein the composition group (1) is made up of hygroscopic compounds alone or a mixture of hygroscopic compounds and small amounts of other constituents miscible therewith and the composition group (2) is made up of one or at least two other constituents which may be mixed with each other, and further the way of dividing those constituents is optimized in accordance with the guideline for designing granules of a composite structure that the composition group (1) is formed into the core of each granule, the composition group (2) is formed into at least one coating layer on each core and organic acids relating to the invention are incorporated on the coating layer side. Thus, the present granules are produced.

The term “spherical granules” as used in the invention refers to the granules formed by granulating a powdery matter in a spherical shape. The spherical shape may be a perfect sphere or not, and can include granular shapes generally referred to as the so-called pellet, pill and bead. The suitable average diameter of granules is from 0.5 to 20 mm, preferably from 1 to 15 mm, particularly preferably 2 to 10 mm. And the present effects become pronounced when the proportion of granules having average diameters smaller than 0.5 mm is at most 10 mass %, preferably 0 to 5 mass %, of the granular solid processing agent.

The present solid processing agent can be granulated in various shapes, such as spherical, columnar, prism-like and indefinite shapes. In the case of granules having a single composition, spherical and indefinite shapes are preferred in terms of easy granulation. In the case of granules having a core-shell structure, on the other hand, it is preferable that each core therein has a spherical shape in terms of easy coating of many ingredients thereon or an indefinite shape in terms of easy production thereof. In ease case, spherical and indefinite shapes are favorable. The suitable average diameter of the present granules is from 0.1 to 5 mm, preferably from 0.2 to 4 mm, especially preferably from 0.3 to 3 mm.

Granulation for forming granules of a single composition, granulation for forming cores of granules having a core-shell structure and granulation for providing coating layers on the core formed can be carried out using a wide variety of known granulation processes. Various granulation processes applicable in the invention are described in Zouryu Handbook (“Granulation Handbook”, compiled by Nippon Funtai Kogyo Gijutu Kyokai, which is named “The Association of Powder Process Industry and Engineering, JAPAN (APPIE)” in English) and publications including JP-A-4-221951 and JP-A-2-109043. Of those processes, the following typical granulation processes are preferred. However, the processes usable in the invention should not be construed as being limited thereto.

(1) Rolling Granulation Process (Zouryu Handbook, page 133)

A granulation process in which a solution (binder) is sprayed on to a feed stock powder while rolling the powder in a rotating container, such as a rotating drum or dish, and the powder is progressing rapidly with coalescence as the interfacial energy is used as an impetus to the coalescence, resulting in formation of granules.

(2) Compression Granulation Process (Zouryu Handbook, page 199)

A process referred to as “briquetting” in which a feedstock powder undergoes molding granulation through compression and molding between two revolving rolls on the surfaces of which briquette pockets are carved, or a process referred to as “compacting” in which a feedstock powder is formed into surface-smoothed platy flakes and then the flakes are crushed.

(3) Agitation Granulation Process (Zouryu Handbook, page 379)

A process of performing granulation via coalescence, wherein a forced flow motion is given to a feed stock powder by use of agitation blades installed in a container as a solution is sprayed onto the powder, thereby causing coalescence.

(4) Extrusion Granulation Process (Zouryu Handbook, page 169)

A process of granulating a feedstock by extrusion from pores of a die-or screen. As an extrusion mechanism, a screw, roll, blade, self-forming or ram mechanism can be used.

(5) Crush Granulation Process (Zouryu Handbook, page 349)

There are a dry process and a wet process. In a dry process, the briquettes or compact flakes obtained using the foregoing compression granulation process are crushed into granules. In a wet process, on the other hand, the powdery material is humidified in advance, then kneaded and further crushed into granules. In both processes, fragmentation by compression crushing is performed by application of impact with a hammer or shear with a cutter, or by use of a rough-toothed rolls or waveform rolls.

(6) Fluidized-bed Granulation Process (Zouryu Handbook, page 349)

A granulation process involving an operation of spraying a powder with a binder while keeping the powder in a state of being suspended in a fluid blowing upward from the underside. Although this operation belongs to a unit operation referred to as fluidization, it is also possible to use a multifunctional fluidized-bed granulator in which this unit operation is combined with rolling and agitating actions.

(7) Coating Granulation Process (Zouryu Handbook, page 409)

A granulation process which involves forming particles bearing atomized solutions of coating substances and a binder on their individual core surfaces, and making the particles adhere to one another. Examples of a coating method usable therein include pan coating carried out under rolling with a rotating drum, rolling coating carried out under rolling with a rotating disk, fluidized-bed coating carried out forming a fluidized bed by airflow, and centrifugal flow coating carried out setting up a planetary motion by use of centrifugal force generated by rotation of a rotor and slit air.

(8) Fusion Granulation Process (Zouryu Handbook, page 227)

A process of injecting a material in a fused state or dropping it onto a plate, thereby cooling and solidifying the fused material in the form of fine particles or flakes.

(9) Atomization-drying Granulation Process (Zouryu Handbook, page 249 page)

A granulation process which involves atomizing a solution, paste or suspension in hot-air stream on the inside of a drying tower and, at the same time, evaporating the moisture, thereby forming dried particles.

(10) Liquid-phase Granulation Process (Zouryu Handbook, page 439)

A capsule granulation process known as a process of producing microcapsules. Specifically, an interfacial polymerization process, an in-solution cured coating process, an emulsion process, a contents exchange process and a spray drying process are known.

(11) Vacuum Freeze Granulation Process (Zouryu Handbook, page 469)

A method of forming a granulated matter from a moist material, which cannot keep a granular form at room temperature, by utilizing its frozen state (solidification by cooling).

In the invention, it is advantageous to carry out the granulation of core by compression granulation process. By use of a compacting process in particular, the present effects are markedly enhanced. And it is preferable that the coating on the core is performed according to a rolling granulation process, a fluidized-bed granulation process or a coating granulation process. In particular, the coating granulation with a centrifugal flow-type coating machine is preferred because it can fully achieve the present effects.

The present granules prefer to have water-soluble polymer coatings on their surfaces. The water-soluble polymer used for coating has no particular restriction as to its kind, but one or more polymers selected from synthetic, semi-synthetic or natural water-soluble macromolecular substances can be used. Examples of such macromolecular substances include gelatin, pectin, polyacrylic acid, polyacrylates, polyvinyl alcohol, modified polyvinyl alcohol, polyvinyl pyrrolidone, vinyl pyrrolidone-vinyl acetate copolymer, polyethylene glycol, hydroxypropylmethyl cellulose, sodium salt of carboxymethyl cellulose, hydroxyethyl cellulose, hydroxypropyl cellulose, methyl cellulose, ethyl cellulose, alginates, xanthangum, gumarabic, tragacanth gum, karaya gum, carrageenan, and methyl vinyl ether-maleic anhydride copolymer. Of these polymers, polyethylene glycol, polyvinyl pyrrolidone, hydroxypropyl cellulose, methyl cellulose, gum arabic and carrageenan are preferably used alone or in combination of two or more thereof.

The amount of water-soluble polymer coated has no particular limitation as far as it is within the usual coating amount range. However, the suitable proportion of such a coating to each granule is from 0.001 to 10 mass %, preferably 0.01 to 5 mass %. As a method for coating water-soluble polymers, any of known methods can be used without particular restrictions. However, it is preferable to use the foregoing rolling, agitation, fluidized-bed, coating, fusion or atomization-drying granulation process. And it is particularly advantageous to adopt a method of spray-coating the surface of each granule with an aqueous polymer solution having its concentration in the range of 1 to 50% in the rolling, fluidized-bed, coating or atomization granulation process, and then drying the polymer coating.

Containers used for the present granular processing agents can take a bag or bottle form, and their packaging materials may be any of paper, plastic and metal. From the viewpoint of loads on the environment, bag-form and bottle-form containers made of paper or plastic films are preferable. Further, barrier materials for packaging use are used to advantage from the viewpoint of various kinds of stability. In particular, plastic materials having oxygen permeability of 200 mL/m²∘24 hrs ∘Pa or below are favorable. Incidentally, the oxygen permeability coefficient can be determined by the method described in O₂ Permeation of Plastic Container, Modern Packing; N. J. Calyan, 1968, The December issue, pages 143-145. Examples of a plastic material suitable for packaging include polyvinylidene chloride (PVDC), nylon (NY), polyethylene (PE), polypropylene (PP), polyester (PES), ethylene-vinyl acetate copolymer (EVA), ethylene-vinyl alcohol copolymer (EVAL), polyacrylonitrile (PAN), polyvinyl alcohol (PVA) and polyethylene-terephthalate (PET). For the purpose of reducing oxygen permeability, it is effective to use PVDC, NY, FE, EVA, EVAL and PET.

In using a packaging material for the granular processing agent, the material is molded into a specific form, such as the form of a film, a bag or a bottle. When a solid photographic processing agent is packaged in a barrier film, the film thickness adequate for protecting the processing agent from moisture is in the range of 10 to 150 μm. The barrier film suitable for such packaging use may be a simple material selected from polyethylene terephthalate film, polyolefin film such as polyethylene or polypropylene film, craft paper to which moisture resistance can be imparted by polyethylene, waxed paper, moisture-resistant cellophane, glassine, polyester film, polystyrene film, polyvinyl chloride film, vinylidene chloride-maleic acid copolymer film, polyvinylidene chloride film, polyamide film, polycarbonate film, acrylonitrile resin film, metal foil such as aluminum foil, or metallized polymer film, or a composite material made up of two or more of the films recited above.

High-barrier (highly shielding) film packaging materials made of composite materials, such as (a) a composite of polyethylene terephthalate and low-density polyethylene, (b) a composite of vinylidene chloride-maleic acid copolymer-coated cellophane and low-density polyethylene, (c) a composite of polyethylene terephthalate, vinylidene chloride-maleic acid copolymer and low-density polyethylene, (d) a composite of nylon and low-density polyethylene, (e) a composite of low-density polyethylene, vinylidene chloride-maleic acid copolymer and low-density polyethylene, (f) a composite of nylon, EVAL and low-density polyethylene, (g) a composite of polyethylene terephthalate, EVAL and low-density polyethylene and (h) aluminum-evaporated polyethylene terephthalate, can be used to particular advantage from the viewpoints of high imperviousness to water, gas and light, ruggedness and flexible sealing (working) capability. As these high-barrier packaging materials, the materials described in Kinousei Housouzairyou no Shintenkai (which might be translated “New Development of Functional Packaging Materials), Toray Research Center (February, 1990), can be used.

The materials for the container having low oxygen permeability and low water-vapor permeability as disclosed in JP-A-63-17453, and the vacuum packaging materials disclosed in JP-A-4-19655 and JP-A-4-230748 can also be used as suitable container materials.

The present granular processing agents each can be used in a mode of being loaded in an automatic developing machine as it is kept in a container and made available for photographic processing. The container suitable for this case is a container made by using, as a single constituent resin, high-density polyethylene (abbreviated as “HDPE” hereinafter) having a density of 0.941 to 0.969 and a melt index of 0.3 to 5.0 g/10 min. The preferable density of polyethylene used as the constituent resin is in the range of 0.951 to 0.969, especially in the range of 0.955 to 0.965, and the preferable melt index thereof is in the range of 0.3 to 4.0 g/10 min. These melt index values are values determined under a load of 2.16 kg at a temperature of 190° C. in accordance with the method defined in ASTM D1238. The suitable thickness of this container is from 500 to 1,500 μm. However, the containers for the processing agents used in the invention should not be construed as being limited to the foregoing HDPE containers convenient for loading in a developing machine, but general-purpose containers made from container materials other than HDPE, such as polyethylene terephthalate (PET), polyvinyl chloride (PVC) and low-density polyethylene, and containers made from HDPE whose density and melt index are out of the aforementioned ranges can also be used.

Next, constituent chemicals of each processing agent are illustrated. A granular processing agent according to the invention can be applied to any of processing agents for a developer, a bleaching bath, a fixing bath, a bleach-fix bath and, if necessary, a stabilizing bath, whether the processing agents are used for color photographic materials or black-and-white photographic materials, or whether the processing agents are used for picture-taking photographic materials or prints.

Incidentally, as to the terms “development” and “development-processing” and the terms “developing agent” and “development-processing agent”, there are a case of using them in a broad sense and a case of using them in a narrow sense. In the broad-sense case, the terms refer to a series of processing steps generally from a development step to a drying step and processing agents used for these steps. In the narrow-sense case, on the other hand, the terms refer to a development step alone and a processing agent for the development step. When whether those terms used in this specification admit of wide interpretation or narrow interpretation is obscure even from the context, the terms “processing” and “processing agent” are used for wide interpretation, and the terms “development” and “development-processing agent” are used for narrow interpretation.

The constituents of a color development-processing agent are described to begin with. Preferred examples of a color development-processing agent include known aromatic primary amine color developing agents, especially p-phenylenediamine derivatives. Representatives thereof are recited below. However, these representative compounds should not be construed as limiting the scope of color developing agents usable in the invention.

1) N,N-diethyl-p-phenylenediamine

2) 4-Amino-N,N-diethyl-3-methylaniline

3) 4-Amino-N— (P-hydroxyethyl)-N-methylaniline

4) 4-Amino-N-ethyl-N-(β-hydroxyethyl)aniline

5) 4-Amino-N-ethyl-N-(β-hydroxyethyl)-3-methylaniline

6) 4-Amino-N-ethyl-N-(3-hydroxypropyl)-3-methylaniline

7) 4-Amino-N-ethyl-N-(4-hydroxybutyl)-3-methylaniline

8) 4-Amino-N-ethyl-N-(β-methanesulfonamidoethyl)-3-methyl-aniline

9) 4-Amino-N,N-diethyl-3-(β-hydroxyethyl)aniline

10) 4-Amino-N-ethyl-N-(β-methoxyethyl)-3-methylaniline

11) 4-Amino-N-(β-ethoxyethyl)-N-ethyl-3-methylaniline

12) 4-Amino-N-(3-carbamoylpropyl)-N-n-propyl-3-methyl-aniline

13) 4-Amino-N-(4-carbamoylbutyl)-N-n-propyl-3-methylaniline

14) N-(4-Amino-3-methylphenyl):-3-hydroxypyrrolidine

15) N-(4-Amino-3-methylphenyl)-3-(hydroxymethyl) pyrrolidine

16) N-(4-Amino-3-methylphenyl)-3-pyrrolidine carboxamide

Of the p-phenylenediamine derivatives recited above, Compounds 5), 6), 7), 8) and 12) are preferred over the others. In particular, Compounds 5) and 8) are advantageous. In general these p-phenylenediamine derivatives each take the form of a salt, such as sulfate, hydrochloride, sulfite, naphthalenesulfonate or p-toluenesulfonate, when they are in a solid matter state. In using the granulated processing agent composition, it is mixed with an established proportion of water and formed into a working solution such as a developer or a replenisher for development (Hereinafter, these working solutions are both referred to as a developer unless it has a particular significance to make a distinction between the developer and the replenisher for development. Similarly thereto, the developing agent and the replenishing agent for development are both referred to as developing agent.) As to the content of an aromatic primary amine developing agent in a development-processing agent, the developing agent is added to a working solution in such a concentration as to make its amount per liter of developer fall within the range of 2 to 200 millimoles, preferably 6 to 100 millimoles, particularly preferably 10 to 40 millimoles.

Depending on the type of photosensitive materials to be developed, there are cases where the color development-processing agent contains a small amount of sulfite ion, or in other cases, substantially no sulfite ion is contained in the color development-processing agent. In the invention, however, it is preferable to add a small amount of sulfite ion to the color development-processing agent. The sulfite ion has remarkable preservative action, but there may be cases where the sulfite ion present in excessive amounts exerts undesirable influences on photographic properties at the step of color development. In addition, the color development-processing agent may contain a small amount of hydroxylamine. When the hydroxylamine (which is generally used in the form of hydrochloride or sulfate, but the salt form is omitted hereinafter) is contained, it functions as a preservative of the developer as with the sulfite ion. As the hydroxylamine is apt to exert undesirable influences on photographic characteristics because of its own silver-development activity, the addition amount thereof is required to be small.

To the color development-processing agent, organic preservatives may be added as well as the aforementioned hydroxylamine and sulfite ion. The term “organic preservatives” as used herein refers to all of the organic compounds capable of reducing a deterioration speed of an aromatic primary amine color developing agent when incorporated in the solution for processing photosensitive materials. Specifically, they are organic compounds having the function of preventing air oxidation of the color developing agent. Especially effective organic preservatives include not only the hydroxylamine derivatives as recited above but also hydroxamic acids, hydrazides, phenols, α-hydroxyketones, α-aminoketones, sugars, monoamines, diamines, polyamines, quaternary ammonium salts, nitroxy radicals, alcohol compounds, oximes, diamide compounds and condensed-ring amines. These organic preservatives are disclosed in JP-A-63-4235, JP-A-63-30845, JP-A-63-21647, JP-A-63-44655, JP-A-63-53551, JP-A-63-43140, JP-A-63-56654, JP-A-63-58346, JP-A-63-43138, JP-A-63-146041, JP-A-63-44657, JP-A-63-44656, U.S. Pat. Nos. 3,615,503 and 2,494,903, JP-A-52-143020, and JP-B-48-30496.

As other preservatives, the various metals disclosed in JP-A-57-44148 and JP-A-57-53749, the salicylic acids disclosed in JP-A-59-180588, the alkanolamines disclosed in JP-A-54-3532, the polyethyleneimines disclosed in JP-A-56-94349 and the aromatic polyhydroxy compounds disclosed in U.S. Pat. No. 3,746,544 may be added, if needed. In particular, alkanolamines, such as triethanolamine and triisopropanolamine, substituted or unsubstituted dialkylhydroxylamines, such as disulfoethylhydroxylamine and diethylhydroxylamine, or aromatic polyhydroxy compounds may be added of those organic preservatives, the hydroxylamine derivatives are described in detail in JP-A-1-97953, JP-A-1-186939, JP-A-1-186940 and JP-A-1-187557. The addition of hydroxylamine derivatives in combination with amines in particular is also effective from the viewpoint of enhancing stability of a color developer and consistency during the continuous processing. Examples of such amines include the cyclic amines as disclosed in JP-A-63-239447, the amines as disclosed in JP-A-63-128340, and the other amines as disclosed in JP-A-1-186939 and JP-A-1-187557. The appropriate proportion of preservatives in the processing agent depends on the species of the preservatives. In general, the preservatives are added to a working solution so as to have a concentration that their amount per liter of developer fall within the range of 1 to 200 millimoles, preferably from 10 to 100 millimoles.

To a color development-processing agent, such as a development-processing agent for color paper, chloride ion may be added when required. In many of usual cases, the chloride ion concentrations in color developers (especially developers for color print materials) are within the range of 3.5×10⁻² to 1.5×10⁻¹ mole/liter. However, there are also many cases where the addition of chloride ion to a development-processing agent for replenishment is unnecessary, because chloride ion is generally released into a developer as a by-product of development. For instance, development-processing agents used for photosensitive materials of picture-taking type need not contain chloride ion.

Then, processing agents for the desilvering step are explained. To begin with, bleaching agents used for a bleaching bath and a bleach-fix bath in color photographic processing are described. Although any of known bleaching agents can be used in a bleaching bath and a bleach-fix bath, organic complex salts of Fe(III) (e.g., Fe(III) complex salts of aminopolycarboxylic acids), organic acids such as citric acid, tartaric acid and malic acid, persulfates and hydrogen peroxide are used to particular advantage of these bleaching agents, organic complex salts of Fe(III) are preferred in particular from the viewpoints of rapid processing and prevention of environmental pollution. Examples of an aminopolycarboxylic acid and salts thereof which are useful for forming organic complex salts of Fe(III) include not only biodegradable aminopolycarboxylic acids, such as ethylenediaminedisuccinic acid (SS body), N-(2-caboxylatoethyl)-L-aspartic acid, β-alaninediacetic acid and methyliminodiacetic acid, but also ethylenediaminetetraacetic acid, diethylenetriaminepentaacetic acid, 1,3-diaminopropanetetraacetic acid, propylenediaminetetraacetic acid, nitrilotriacetic acid, cyclohexanediaminetetraacetic acid, iminodiacetic acid and glycoletherdiaminetetraacetic acid. The salts formed from these acids may be any of sodium, potassium, lithium and ammonium salts. Of those compounds, ethylenediaminedisuccinic acid (SS body), N-(2-carboxylatoethyl)-L-aspartic acid, β-alaninediacetic acid, ethylenediaminetetraacetic acid, 1,3-diaminopropanetetraacetic acid and methyliminodiacetic acid are preferred over the others because their Fe(III) complex salts can ensure good photographic properties. These complex salts of ferric ion may be used in the complex salt form itself, or they may be formed in a solution by use of ferric salts, such as ferric sulfate, ferric chloride, ferric nitrate, ammonium ferric sulfate and ferric phosphate, and chelating agents such as aminopolycarboxylic acids. Further, the chelating agents may be added in excess of an amount required for forming ferric ion complex salts of iron complex salts, aminopolycarboxylic acid-iron complex salts are preferred over the others.

The addition amount of a bleaching agent is determined so that the processing solution prepared has a bleaching agent concentration of 0.01 to 1.0 mole/liter, preferably 0.03 to 0.80 mole/liter, far preferably 0.05 to 0.70 mole/liter, particularly preferably 0.07 to 0.50 mole/liter.

It is preferable that the bleaching agent, the agent for a bleach-fix bath or the fixing agent contains a wide variety of known organic acids (e.g., glycolic acid, succinic acid, maleic acid, malonic acid, citric acid, sulfosuccinic acid), organic bases (e.g., imidazole, dimethylimidazole), or the compounds represented by formula (A-a) disclosed in JP-A-9-211819, including 2-picolinicacid, and the compounds represented by formula (B-b) disclosed in the same patent document as cited above, including kojic acid. The suitable addition amount of such compounds is determined so that the concentration thereof in a processing solution prepared falls within the range of 0.005 to 3.0 mole/liter, preferably 0.05 to 1.5 mole/liter.

Next, fixing agents (including fixing agents of a bleach-fix bath for color photography) are described collectively. The compounds used as these fixing agents are known fixing chemicals, namely water-soluble silver halide solvents, such as thiosulfates including sodium thiosulfate and ammonium thiosulfate, thiocyanates including sodium thiocyanate and ammonium thiocyanate, thioether compounds including ethylenebisthioglycolic acid and 3,6-dithia-1,8-octanediol, and thioureas. These compounds can be used alone or as mixtures of two or more thereof. On the other hand, a special bleach-fix bath containing a combination of the fixing agent as disclosed in JP-A-55-155354 and a large amount of halide, such as potassium iodide, can also be employed. In the invention, the use of thiosulfates, especially ammonium thiosulfate, is advantageous. The suitable concentration of fixing chemicals in each of fixing and bleach-fix baths prepared from granular processing agents is from 0.3 to 3 moles, preferably 0.5 to 2.0 moles, per liter of the prepared solution.

The suitable pH range at the time when the present agent for a bleach-fix bath or the present fixing agent is dissolved is from 3 to 8, preferably from 4 to 8. When the pH is lower than the foregoing range, the desilvering capability is increased, but deterioration of the baths and conversion of cyan dyes into leuco compounds thereof are accelerated. When the pH is higher than the foregoing range, on the other hand, the desilvering is retarded and stains are liable to develop. The nH range of a bleaching bath prepared from the present granular agent is 8 or below, preferably from 2 to 7, particularly preferably from 2 to 6. When the pH is lower than the foregoing lower limit, deterioration of the bath and conversion of cyan dyes into leuco compounds thereof are accelerated. When the pH is higher than the foregoing upper limit, on the other hand, desilvering is retarded and stains are liable to develop. For the pH adjustment, the solid-state acids as recited above, the solid-state alkalis as recited above, such as potassium hydroxide, sodium hydroxide, lithium hydroxide, lithium carbonate, sodium carbonate and potassium carbonate, and acidic or alkaline buffers can be added on an as needed basis.

The agent for a bleach-fix bath can further contain various other additives, such as a brightening agent, an antifoaming agent or a surfactant, and polyvinyl pyrrolidone. Additionally, it is also permitted to incorporate the brightening agent into the foregoing color development-processing agent so that its concentration in the prepared developer becomes 0.02 to 1.0 mol/liter. It is appropriate that the agent for a bleach-fix bath and the fixing agent contain as preservatives sulfite ion-releasing compounds, such as sulfites (e.g., sodium sulfite, potassium sulfite, ammonium sulfite), hydrogen sulfites (e.g., ammonium hydrogen sulfite, sodium hydrogen sulfite, potassium hydrogen sulfite) and metabisulfites (e.g., potassium metabisulfite, sodium metabisulfite, ammonium metabisulfite), and arylsulfinic acids, such as p-toluenesulfinic acid and m-carboxybenzenesulfinic acid. The suitable concentration of these compounds is from about 0.02 to about 1.0 mol/l, based on sulfite ions or sulfinate ions.

In addition to the preservatives as recited above, ascorbic acid, carbonyl-hydrogen sulfite adducts or carbonyl compounds may be added as preservatives.

After the conclusion of the fix or bleach-fix processing step, processing with a stabilizing bath as a washing substitute or a stabilizing bath for image stabilization is performed in many cases. These baths are low in concentration, so the granular processing agent does not have much effect. However, granulated processing agents can be prepared for such baths, if desired. To the processing agent for a stabilizing bath, the method of reducing calcium and magnesium ions as disclosed in JP-A-62-288838 can be applied very effectively. In addition, it is possible to use in the stabilizing bath the isothiazolone compounds and thiabendazoles disclosed in JP-A-57-8542, the chlorine-containing bactericides, such as sodium salt of chlorinated isocyanuric acid disclosed in JP-A-61-120145, the benzotriazoles disclosed in JP-A-61-267761, copper ion, and other bactericides as described in Hiroshi Horiguchi, Bohkin Bohbai no Kagaku (which means “Antibacterial and Mold-proof Chemistry”), Sankyo Shuppan (1986); Biseibutsu no Mekkin Sakkin Bohbai Gijutsu (which means “Arts of Sterilizing and Pasteurizing Microbes, and Proofing Against Molds”), compiled by Eisei Gijutsukai, published by Kogyo Gijutsu Kai in 1982; and Bohkin-Bohbaizai Jiten (which means “Encyclopedia of Anti-bacteriaandAnti-molds”), compiled by Nippon Bohkin Bohbai Gakkai.

Further, aldehydes including formaldehyde, acetoaldehyde and pyruvic aldehyde, the methylol compounds and the hexamethylenetetramines disclosed in U.S. Pat. No. 4,786,583, the hexahydrotriazines disclosed in JP-A-2-153348, the formaldehyde-hydrogen sulfite adducts disclosed in U.S. Pat. No. 4,921,779, and the azolylmethylamines disclosed in EP-A-504609 and EP-A-519190 may be added in order to prevent discoloration of dyes and development of stains by deactivation of residual magenta couplers. Furthermore, surfactants as agents for draining water off and chelating agents represented by EDTA as water softening agent can also be used.

Then the processing steps performed using the present processing agents are described. In the case of color photographic materials, the photographic processing to which the invention is applied includes a color development step, a desilvering step, a washing step or a step of using a stabilizing bath, and a drying step. Further, an auxiliary step, such as a rinsing step, an intermediate washing step or a neutralizing step, may also be inserted in each individual interval between two successive steps. The desilvering processing is performed by one-step processing with a bleach-fix bath or two-step processing constituted of a bleaching step and a fixing step. In addition to the stabilizing bath as a washing step substitute, a processing bath for image stabilization can be inserted between the washing step or the step with a stabilizing bath as a washing substitute and the drying step. In the case of black-and-white photographic materials, the photographic processing include a developing step, a fixing step, a washing step and a drying step, and an auxiliary-step, such as an intermediate washing step including rinsing, or a neutralizing step, can also be inserted in each individual interval between two successive steps. The processing method adopted in the invention may be any of processing methods of rapid development type, low replenishment rate type and internationally compatible standard type.

The color development step is an immersion-in-bath processing step in which photosensitive materials are immersed in a developing bath, and the developing bath is an alkaline continuous-phase liquid which contains its ingredients in a dissolved state. A developer and a replenisher for development are prepared and used in a development tank and a replenishment tank, respectively.

When the photosensitive materials to undergo development-processing are color picture-taking materials, such as color negative and color reversal films, the processing temperature is from 30° C. to 40° C. in general cases, while in the rapid-processing cases the processing temperature is in the range of 38 to 65° C., preferably 40 to 55° C. The development-processing time is from 1 to 8 minutes in general cases, while in the rapid-processing cases the processing time is in the range of 15 to 195 seconds, preferably 20 to 150 seconds. The replenishment rate is 600 milliliter per m² of photosensitive material in the standard development, while in the processing at a low replenishment rate the replenishment volume per m² of photosensitive material is from 30 to 390 milliliter, preferably from 50 to 300 milliliter, and in some special cases it may be from 80 to 200 milliliter. When the photosensitive materials to undergo development-processing are color print materials such as color photographic paper, the processing temperature is from 30° C. to 40° C. in general cases, while in the rapid-processing cases the processing temperature is in the range of 38 to 65° C. The development-processing time is from 30 seconds to 3 minutes in general cases, while in the rapid-processing cases the processing time is in the range of 5 to 45 seconds, preferably 5 to 20 seconds. The replenishment rate is 161 milliliter per m² of photosensitive material in the standard development, while in the processing at a low replenishment rate the replenishment volume per m² of photosensitive material is from 10 to 150 milliliter, preferably from 20 to 100 milliliter, and in certain cases the replenishment volume may be in the range of 25 to 80 milliliter.

In the color photographic processing, photosensitive materials are conducted into the desilvering step subsequently to the development-processing step, and processed with a bleaching bath and a bleach-fix bath. The bleach time is generally from 10 seconds to 6 minutes and 30 seconds, preferably from 10 seconds to 4 minutes and 30 seconds, particularly preferably from 15 seconds to 2 minutes. The processing time of bleach-fix processing according to the invention is from 5 to 240 seconds, preferably from 10 to 60 seconds. The processing temperature is in the range of 25° C. to 60° C., preferably 30° C. to 50° C. The replenishment rate is from 10 ml to 250 ml, preferably from 10 ml to 100 ml, particularly preferably from 15 ml to 60 ml, per m² of photosensitive material. In the black-and-white photographic processing, the processing with a fixing bath is performed subsequently to the development step. The processing time in the fix processing is from 5 to 240 seconds, preferably from 10 to 60 seconds, and the processing temperature is from 25 to 60° C., preferably from 30 to 50° C. And the replenishment rate is from 20 to 250 ml, preferably from 30 to 100 ml, particularly preferably from 15 to 60 ml, per m² of photosensitive material.

In general, wash or stabilizing bath processing is carried out after the desilvering processing in the case of color photographic materials, while wash processing is carried out after the fix processing in the case of black-and-white photographic materials. The volume of washing water used in the washing step can be selected from a wide range depending on the characteristics (e.g., properties of constituents used, including couplers) and uses of photosensitive materials to undergo the processing, the washing temperature, the number of wash tanks used (the number of stages) and various other conditions. The relation between the number of wash tanks and the water volume in the multi-stage counter-current system can be determined by the method described in Journal of the Society of Motion Picture and Television Engineers, vol. 64, pp.248-253 (May, 1955). The suitable number of stages in the multi-stage counter current system is generally from 3 to 15, preferably 3 to 10.

The multi-stage counter-current system enables a significant reduction in the volume of wash water, but causes a problem that a scum formed by propagation of bacteria resulting from an increase in staying time of water in the wash tank adheres to photosensitive materials processed therein. As a solution of this problem, the use of a stabilizing bath containing antibacterial and antimold agents is preferred.

The suitable pH in the wash step or the stabilization step is from 4 to 10, preferably from 5 to 8. The temperature therein, though can be set variously depending on the uses and characteristics of photosensitive materials, can be set generally within the range of 20 to 50° C., preferably within the range of 25 to 45° C. Subsequently to the wash and/or stabilization step, a drying operation is carried out. Just after the washing step, it is also possible to absorb water brought in image-formed layers by means of squeegee rollers or cloth from the viewpoint of reduction in quantity of the water brought in, and thereby the drying can be expedited. For improvement in drying efficiency on the side of a dryer, as a matter of course, it is possible to increase a drying speed by raising a drying temperature or modifying the shape of blowing nozzles to increase the blowing strength of a drying air. Further, as disclosed in JP-A-3-157650, the drying speed can also be increased by making an adjustment to the blowing angle of drying air with respect to photosensitive materials and devising a removal method of drying-air emission.

Up to this point we have described the photographic processing method using the present granular processing agents. Next the processing apparatus performing the photographic processing is illustrated.

The photographic processing relating to the invention is carried out by use of an automatic processor. The automatic processor preferably used in the invention is described below.

It is appropriate in the invention that the linear speed of transport in the automatic processor be 5,000 mm/min or below, preferably from 200 mm/min to 4,500 mm/min, particularly preferably from 500 to 3,000 mm/min. When the processing solutions relating to the invention are in a state that they are placed in processing tanks and replenisher tanks, it is advantageous for them to have the smallest possible contacted areas with air (opening area). For instance, taking the value obtained by dividing the opening area (cm²) by the volume (cm³) of a processing solution placed in a tank as an opening rate, the appropriate opening rate is 0.01 (cm⁻¹) or below, preferably 0.005 or below, particularly preferably 0.001 or below.

In order to reduce the contacted area with air, it is preferable to float a solid or liquid means for avoiding contact with air on the surface of a solution placed in a processing tank or a replenisher tank. Specifically, it is preferable to float a plastic-made float on the solution surface or cover the solution surface with a liquid having no compatibility and causing no chemical reaction with the solution. Suitable examples of such a liquid include liquid paraffin and liquid saturated hydrocarbons.

The shorter the aerial passage time required for a photosensitive material to move from each processing bath to its adjacent processing bath, namely the crossover time, the more favorable the conditions become for performing rapid processing in the invention. The suitable crossover time is 10 seconds or below, preferably 7 seconds or below, far preferably 5 seconds or below. For achieving such a short crossover time in the invention, it is preferable to use a processing machine for motion picture film, especially adopting a leader transport system. Such a system is used in an automatic developing machine, FP-560B (trade name, made by Fuji Photo Film Co., Ltd.). For transporting leaders and photosensitive materials, it is preferable to adopt the belt conveyance systems disclosed in JP-A-60-191257, JP-A-60-191258 and JP-A-60-191259. Further, the structure of a crossover rack equipped with anti-mixing plates is favorable for reduction of a crossover time and prevention of mixing with processing solutions.

The present granular processing agents each may be supplied directly to a developing machine as a granular composition of a single-part or multiple-part makeup, or may be used in a mode of dissolving the granular processing agent to prepare a replenisher, once storing the replenisher in a replenishment tank and then supplying the replenisher while performing replenishment control.

In order to reduce dust adhesion to a magnetic recording layer coated on a photosensitive material, the stabilizer disclosed in JP-A-6-289559 is used to a advantage. To the present granular processing agents also, the processing specifications disclosed in Kohkai Giho (Journal of Technical Disclosure), Kougi No. 94-4992, page 3, right column, line 15, to page 4, left column, line 32, issued by Hatsumei Kyokai (Japan Institute of Invention and Innovation (JiII)) are applied advantageously. As a developing machine used therein, the film processor disclosed in the Koukai Giho (Journal of Technical Disclosure) citedabove, page 3, right column, lines 22-28, is suitable. Examples of an automatic developing machine and an evaporation correction method suitable for practical use of the present granular processing agents can be found in the Koukai Giho (Journal of Technical Disclosure) cited above, page 5, right column, line 11, to page 7, right column, last line.

Further, photosensitive materials usable in the invention are described. As described above in relation to the aims and the background of the invention, the photosensitive materials usable in the invention include picture-taking color photographic materials, color photographic paper, picture-taking black-and-white photographic materials and black-and-white photographic paper, which prevail in the photo market. These photosensitive materials each have at least one light-sensitive layer on a support. A typical example of such materials is a silver halide photographic material having on a support at least one light-sensitive layer made up of a plurality of silver halide emulsion layers differing from one another in sensitivity but having substantially the same color sensitivity.

In picture-taking multilayer silver halide color photographic materials, each of the light-sensitive layers is a unit light-sensitive layer having sensitivity to any of blue light, green light and red light. As to the arranging order of these unit light-sensitive layers from the support side, it is general to provide a red-sensitive layer, a green sensitive layer and a blue-sensitive layer in the order presented. Depending on the desired purpose, however, the unit light-sensitive layers may be arranged in inverse order, or it is permitted to take an arranging order such that a layer having certain color sensitivity is sandwiched between layers constituting a unit light-sensitive layer having color sensitivity different from that of the layer sandwiched. Further, light-insensitive layers maybe provided between the silver halide light-sensitive layers, and further in the topmost and the lowest positions. In these layers, couplers as described below, DIR compounds and color mix inhibitors may be incorporated. As to the two or more silver halide emulsion layers constituting each unit light-sensitive layer, it is appropriate that a high-speed emulsion layer and a low-speed emulsion layer be arranged in decreasing order of sensitivity toward the support as disclosed in DE 1,121,470 or GB 923,045. On the other hand, as disclosed in JP-A-57-112751, JP-A-62-200350, JP-A-62-206541 and JP-A-62-206543, it is also allowable to arrange a low-speed emulsion layer on the side distant from the support and a high-speed emulsion layer on the side near the support.

For instance, from the side most distant from the support, a low-speed blue-sensitive layer (BL), a high-speed blue-sensitive layer (BH), a high-speed green-sensitive layer (GH), a low-speed green-sensitive layer (GL), a high-speed red-sensitive layer (RH) and a low-speed red-sensitive layer (RL) can be arranged in the order described. The arranging order may also be BH, BL, GL, GH, RH and RL, or it may be BH, BL, GH, GL, RL and RH, too. Further, as disclosed in JP-B-55-34932, the arrangement in the order of blue-sensitive layer/GH/RH/GL/RL from the side most distant from the support can also be adopted. Furthermore, as disclosed in JP-A-56-25738 and JP-A-62-63936, the arrangement in the order of blue-sensitive layer/GL/RL/GH/RH from the side most distant from the support can be adopted, too.

In addition, as disclosed in JP-B-49-15495, it is permitted that three layers differing in sensitivity are arranged in the decreasing order of sensitivity towards a support. Specifically, the silver halide emulsion layer having the highest sensitivity is arranged as the upper layer, the silver halide emulsion layer having the sensitivity lower than that of the upper layer is arranged as the intermediate layer and the silver halide emulsion layer having the sensitivity lower than that of the intermediate layer is arranged as the lower layer. In the case where three layers arranged are different in sensitivity to light but the same in color sensitivity, as disclosed in JP-A-59-202464, the arrangement in the order of the medium-speed emulsion layer, the high-speed emulsion layer and the low-speed emulsion layer from the side distant from the support may also be adopted. The arrangements in other orders, namely the order of high-speed emulsion layer/low-speed emulsion layer/medium-speed emulsion layer and the order of low-speed emulsion layer/medium-speed emulsion layer/high-speed emulsion layer, may be adopted. In the cases of arranging four or more layers differing in sensitivity to light, the order of arrangement may be various as described above.

For improving color reproducibility, as disclosed in U.S. Pat. Nos. 4,663,271, 4,705,744 and 4,707,436, JP-A-62-160448 and JP-A-63-89850, it is favorable that donor layers (CL) having interlayer effects and differing in spectral sensitivity distribution from main light-sensitive layers, such as BL, GL and RL, are arranged in the positions adjacent to or in vicinity of the main light-sensitive layers.

Silver halide suitably used in picture-taking materials is silver iodobromide, iodochloride or iodochlorobromide having an iodide content of about 30 mole % or below. Of these silver halides, silver iodobromide or iodochlorobromide having an iodide content of from about 2 mole % to about 10 mole % is preferred over the others.

The silver halide grains in photographic emulsions may be grains having a regular crystal shape, such as that of a cube, an octahedron or a tetradecahedron, or an irregular crystal shape, such as that of a sphere or a tablet, or grains having crystal defects, such as a twin plane, or grains having a composite crystal shape. The grain size of silver halide may be in a wide range, because grains are formed so as to be suited for each individual light-sensitive layer. Specifically, any grains including fine grains having a projected area diameter of 0.1 to 0.2 μm and coarse grains having a projected area diameter of 1.0 to 10 μm may be used. Further, the emulsions used may be polydisperse or monodisperse emulsions.

In the color photosensitive materials, it is advantageous to use light-insensitive fine-grain silver halide. The light-insensitive fine-grain silver halide is defined as the fine grains of silver halide neither sensitized by image wise exposure for forming dye images nor developed in a substantial sense at the development-processing step. And it is preferable that these fine grains are not fogged in advance. The fine-grain silver halide has a bromide content of 0 to 100 mole %, and may contain chloride and/or iodide, if desired. Preferably, 0.5 to 10 mole % of iodide is contained therein. The suitable average diameter (mean value of diameters of circles having the areas equivalent to projected areas of grains) of fine grains is from 0.01 to 0.5 μm, preferably from 0.02 to 0.2 μm. The fine-grain silver halide can be prepared in the same manner as general light-sensitive silver halide. And it is not necessary for the silver halide grain surface to undergo optical sensitization and spectral sensitization. However, prior to adding them to a coating solution, it is appropriate that known stabilizers, such as triazole compounds, azaindene compounds, benzothiazolium compounds, mercapto compounds or zinc compounds, be added to the coating solution. In the layer containing such fine-grain silver halide, colloidal silver can be incorporated.

It is preferable that the silver coverage of a color photosensitive material used in the invention is 0.6 g/m² or below, particularly 4.5 g/m² or below. As to the color photosensitive material used in the invention, the suitable total layer thickness of all hydrophilic colloidal layers present on the emulsion layer side is 28 μm or below, preferably 23 μm or below, far preferably 18 μm or below, particularly preferably 16 μm or below. And the layer swelling speed T_{1/2} is preferably 30 seconds or below, particularly preferably 20 seconds or below. The term T_{1/2} is defined as the time required for the layer thickness to reach one-half the saturated layer thickness determined as 90% of the maximum swollen layer thickness to which the layer reaches when processed with a color developer at a temperature of 30° C. for a period of 3 minutes and 15 seconds. The term “layer thickness” as used herein means the layer thickness measured under a temperature of 25° C. and a relative humidity regulated at 55% (2 days) And the value of T_{1/2} can be determined by use of a swellometer of the type described in A. Green et al., Photogr. Sci. Eng., Vol. 19, No.2, pp.124-129. The value of T_{1/2} can be adjusted by adding a hardener to gelatin used as a binder, or by changing the aging condition after coating. The suitable rate of swelling is from 150 to 400%. The “rate of swelling” can be calculated from the maximum swollen layer thickness under the aforementioned conditions by use of the equation: (maximum swollen layer thickness—layer thickness)/layer thickness.

On the other hand, the crystal shape of silver halide grains contained in photographic emulsions preferably used for making prints maybe any of regular crystal shapes, such as those of a cube, a tetradecahedron and an octahedron, shapes having irregular crystal habits, such as a sphere and a tablet, and composites of these shapes. As to the tabular grains, one pair of parallel surfaces perpendicular to the thickness direction is referred to as the major surfaces. In the invention, it is preferable to use photographic emulsions containing tabular grains having {111} or {100} faces as major surfaces. With respect to the formation of {111} tabular grains, the methods using various crystal-phase controllers are disclosed. For instance, the compounds disclosed in JP-A-2-32 (Compound Examples 1 to 42) are used to advantage.

The grains having a silver chloride content of at least 80 mole % are referred to as high-chloride silver halide grains. To such grains, it is appropriate that the chloride content be 95 mole % or more. And it is preferable that the grains used in the invention have the so-called core-shell structure constituted of a core part and a shell part surrounding the core part. The suitable chloride content in the core part is at least 90 mole % The core part may be made up of two or more sections differing in halide composition. The suitable proportion of the shell part in each grain is not higher than 50%, especially not higher than 20%, of the total grain volume. The shell part is preferably silver iodochloride or silver iodobromochloride. The suitable iodide content in the shell part is from 0.5 mole % to 13 mole %, especially from 1 mole % to 13 mole %. And the suitable iodide content in the entire grain is not higher than 5 mole %, especially not higher than 1 mole %. It is appropriate that the bromide content be higher in the shell part than in the core part. The suitable bromide content is not higher than 20 mole %, particularly not higher than 5 mole %.

Silver halide grains incorporated in photosensitive materials for photographic paper use have no particular restrictions as to their average grain size (sphere-equivalent diameter on a volume basis, but it is preferable that the average grain size thereof ranges from 0.1 m to 0.8 μm, especially from 0.1 to 0.6 μm. As to the tabular grains, it is appropriate that the circle-equivalent diameters thereof be in the range of 0.2 to 1.0 μm. The term “diameter of each individual silver halide grain” refers to the diameter of a circle having the same area as the projected area of each individual grain on an electron micrograph. The grain thickness is 0.2 μm or below, preferably 0.15 μm or below, particularly preferably 0.12 μm or below. The grain size distribution of silver halide grains may be polydisperse or monodisperse, but it is advantageous that the silver halide grains have a monodisperse size distribution. In particular, it is preferred that the tabular grains constituting at least 50% of the total grains on a projected area basis have a variation coefficient of 20% or below, ideally 0%, with respect to the circle-equivalent diameters thereof.

Then, color photosensitive materials for picture-taking and print-making uses are both described.

Silver halide photographic emulsions usable in the invention can be prepared using the methods as described, e.g., in Research Disclosure (hereinafter abbreviated as “RD”), No. 17643(December 1978), pp. 22-23, entitled “I. Emulsion Preparation and Types”; ibid., No. 18716 (November 1979), p.648; ibid., No. 307105.(Nov. 1989), pp. 863-865; P. Glafkides, Chemie et Physique Photographique, Paul Montel (1967); G. F. Duffin, Photographic Emulsion Chemistry, The Focal Press (1966); and V. L. Zelikman, et al., Making and Coating Photographic Emulsion, The Focal Press (1964). The monodisperse emulsions disclosed in U.S. Pat. Nos. 3,574,628 and 3,655,394, and GB No. 1,413,748 are also used to advantage.

The tabular grains having an aspect ratio of about 3 or above can also be used in the invention. Such tabular grains can be prepared with ease in accordance with the methods as described in Gutoff, Photographic Science and Engineering, vol. 14, pp. 248-257 (1970); U.S. Pat. Nos. 4, 434, 226, 4,414,310, 4,439,048 and 4,439,520; and GB No. 2,112,157. Such grains may be uniform throughout in crystal structure, they may be different in halide composition between the inner part and the outer part, or they may form a layer structure. Further, silver halide phases differing in halide composition may be joined together by epitaxial junction, or compounds other than silver halide, such as silver rhodanide and zinc oxide, may be bonded to a silver halide phase. In addition, mixtures of grains having different crystal forms may be used.

The emulsions mentioned above may have any types of latent images. More specifically, the emulsions may be surface-latent-image type emulsions which form latent images predominantly at the surface of grains, or internal-latent-image type emulsions which mainly form latent images inside the grains, or emulsions of the type which form latent images in both surface and internal parts. However, they are required to be negative emulsions. Of the internal-latent-image type emulsions, the core-shell emulsion of internal latent-image type as disclosed in JP-A-63-264740 may be used, and such an emulsion can be prepared by the method disclosed in JP-A-59-133542. The suitable shell thickness of this emulsion, though varies depending on the conditions of development-processing, is in the range of 3 to 40 nm, particularly 5 to 20 nm.

In general, silver halide emulsions used in the invention are those having undergone physical ripening, chemical ripening and spectral sensitization. The additives used in these sensitizing steps are described in RD No. 17643, RD No. 18716 and RD No. 307105, and the locations where they are described in each of those references are listed below. Color photosensitive materials used in the invention can contain in at least one of their respective constituent layers a mixture of two or more light-sensitive silver halide emulsions differing in at least one characteristic, such as grain size, grain size distribution, halide composition, grain shape or sensitivity. It is advantageous to apply the surface-fogged silver halide grains disclosed in U.S. Pat. No. 4,082,553, the inside-fogged silver halide grains disclosed in U.S. Pat. No. 4,626,498 and JP-A-59-214852, or colloidal silver to light-sensitive silver halide emulsion layers and/or substantially light-insensitive hydrophilic colloidal layers. The term “inside- or surface-fogged silver halide grains” as used herein refers to the silver halide grains capable of being developed uniformly (non-imagewise) irrespective of whether they are present in the unexposed area or the exposed area of photosensitive material. The preparation methods of such grains are described in U.S. Pat. No. 4,626,498 and JP-A-59-214852. The silver halide forming the core of an inside-fogged core-shell silver halide grains may differ in halide composition. The silver halide used for forming inside- or surface-fogged grains may be any of silver chloride, silver chlorobromide, silver iodobromide and silver chloroiodobromide. The photographic additives usable in color photosensitive materials are also described in RDs, and the locations at which they are described are also shown below.

| Kinds of Additives | | RD17643 | RD18716 | RD307105 |
|---|---|---|---|---|
| 1. | Chemical sensi- | p. 23 | p. 648, right | p. 866 |
| | tizer | | column | |
| 2. | Sensitivity | | p. 648, right | |
| | increasing agent | | column | |
| 3. | Spectral sensi- | pp. 23-24 | p. 648, right | pp. 866-868 |
| | tizer and Super- | | column, to | |
| | sensitizer | | p. 649, right | |
| | | | column | |
| 4. | Brightening agent | p. 24 | p. 647, right | p. 868 |
| | | | column | |
| 5. | Light absorbent, | pp. 25-26 | p. 649, right | p. 873 |
| | Filter dye, UV | | column, to | |
| | absorbent | | p. 650, left | |
| | | | column | |
| 6. | Binder | p. 26 | p. 651, left | pp. 873-874 |
| | | | column | |
| 7. | Plasticizer, | p. 27 | p. 650, right | p. 876 |
| | Lubricant | | column | |
| 8. | Coating aid, | pp. 26-27 | p. 650, right | pp. 875-876 |
| | Surfactant | | column | |
| 9. | Antistatic agent | p. 27 | p. 650, right | pp. 876-877 |
| | | | column | |
| 10. | Matting agent | | | pp. 878-879 |

Various kinds of dye-forming couplers can be used in color photosensitive materials. The couplers recited below are preferred in particular.

Examples of yellow couplers used preferably include the couplers represented by formulae (I) and (II) in EP-A-502424, the couplers represented by formulae (1) and (2) in EP-A-51496 (especially Y-28 illustrated on page 18), the couplers represented by formula (I) in claim 1 of EP-A-568037, the couplers represented by formula (I) on column 1, lines 45-55, of U.S. Pat. No. 5,066,576, the couplers represented by formula (I) in paragraph [0008] of JP-A-4-274425, the couplers described in claim 1 on page 40 of EP-A1-498381 (especially D-35 illustrated on page 18), the couplers represented by formula (Y) on page 4 of EP-A1-447969 (especially Y-1 on page 17 and. Y-54 on page 41), and the couplers represented by formulae (II) to (IV) on column 7, lines 36-58, of U.S. Pat. No. 4,476,219 (especially II-17, II-19 (on column 17) and II-24 (on column 19)).

Examples of magenta couplers used preferably include the couplers disclosed in JP-A-3-39737 (L-57 (p. 11, lower right), L-68 (p. 12, lower right) and L-77 (p. 13, lower right)); the couplers disclosed in European Patent No. 456,257, A-4-63 (p. 134), A-4-73 and A-4-75 (p. 139); the couplers disclosed in European Patent No. 486,965, M-4, M-6 (p. 26), and M-7 (p. 27); the coupler disclosed in EP-A-571959, M-45 (p. 19); the coupler disclosed in JP-A-5-204106, M-1 (p. 6); and the coupler disclosed in JP-A-4-362631, M-22 (paragraph [0237]).

Examples of cyan couplers used preferably include the couplers disclosed in JP-A-4-204843, CX-1, 3, 4, 5, 11, 12, 14 and 15 (pp. 14-16); the couplers disclosed in JP-A-4-43345, C-7 and C-10 (p. 35), C-34 and C-35 (p. 37), (1-1) and (1-17) (pp. 42-43); and the couplers represented by formulae (Ia) and (Ib) in claim 1 of JP-A-6-67365.

Examples of polymeric couplers used preferably include the couplers P-1 and P-5 (p. 11) disclosed in JP-A-2-44345.

As couplers capable of forming colored dyes having moderate diffusibility, those disclosed in U.S. Pat. No. 4,366,237, GB No. 2,125,570, EP-B-96873 and DE No. 3,234,533 are suitable. Couplers appropriate for compensating undesired absorption of developed colors include the yellow colored cyan couplers represented by formulae (CI), (CII), (CIII) and (CIV) illustrated on page 5 of EP-A1-456257 (especially YC-86 on page 84), the yellow colored magenta couplers ExM-7 (p. 202), EX-1 (p.249) and EX-7 (p.251) disclosed in the patent document cited above, the magenta colored cyan couplers CC-9 (column 8) and CC-13 (column 10) of U.S. Pat. No. 4,833,069, and the colorless masking couplers disclosed in U.S. Pat. No. 4,837,136 ((2) on column 8) and as formula (A) in claim 1 of WO92/11575 (especially the compounds illustrated on pages 36-45).

Examples of photographically useful group-releasing compounds which can be incorporated include the development inhibitor-releasing compounds represented by formulae (I), (II), (III) and (IV) on page 11 of EP-A1-378236, the bleach accelerator-releasing compounds represented by formulae (1) and (1′) on page 5 of EP-A2-310125, the ligand-releasing compounds represented by LIG-X in claim 1 of U.S. Pat. No. 4,555,478, the leuco dye-releasing compounds exemplified as Compounds 1-6 on columns 3-8 of U.S. Pat. No. 4,749,641, the fluorescent dye-releasing compounds disclosed in claim 1 of U.S. Pat. No. 4,774,181, the development accelerator- or fogging agent-releasing compounds represented by any of formulae (1), (2) and (3) on column 3 of U.S. Pat. No. 4,656,123, and the compounds represented by formula (I) in claim 1 of U.S. Pat. No. 4,857,447, which release groups capable of being converted to dyes only by undergoing elimination.

Examples of additives, other than couplers, which can be added include known dispersing media for oil-soluble organic compounds, latices for impregnation with oil-soluble organic compounds, scavengers for oxidized color developing agents, stain inhibitors, discoloration inhibitors, hardeners, precursors of development inhibitors, stabilizers, antifoggants, chemical sensitizers, dyes, dispersions of microcrystalline dyes, and UV absorbers.

The invention can be applied to various kinds of color photosensitive materials including color negative films for amateur use or motion picture use, color reversal films for slide or television use, color photographic paper and color positive films. In addition, the application to the lens-equipped film units disclosed in JP-B-2-32615 and JP-UM-B-3-39784 is also favorable.

Supports used suitably in the invention include the materials as disclosed in the above-cited RD, No. 17643, p. 28, ibid., No. 18716, p. 647, right column, to p. 648, left column, and ibid., No. 307105, p. 879.

It is preferable that the color photosensitive materials used in the invention are each provided with hydrophilic colloid layers (referred to as backing layers) having a total dry thickness of 2 to 20 μm on the side opposite to the emulsion layer side. And it is appropriate that these backing layers contain the additives as recited above, such as light absorbents, filter dyes, ultraviolet absorbents, antistatic agents, hardeners, binders, plasticizers, lubricants, coating aids and surfactants. The suitable rate of swelling caused in the total backing layers is from 150 to 500%.

Many of color photosensitive materials used in the invention have magnetic recording layers. The term “magnetic recording layer” as used herein is defined as the layer formed by coating on a support a coating composition made up of magnetic particles dispersed in a binder and an aqueous or organic solvent.

In color photographic paper for color prints, a reflective support is employed. As the reflective support, a support material laminated with a plurality of waterproof resin layers, such as polyethylene or polyester layers, and containing a white pigment, such as titanium dioxide, in at least one of the waterproof resin layers is preferred in particular.

Further addition of a brightening agent to at least one of the waterproof resin layers is preferable. Alternatively, a brightening agent may be dispersed in a hydrophilic colloid layer of the photographic paper. Examples of a brightening agent suitably used in such layers include benzoxazole-type, coumarin-type and pyrazoline-type brightening agents, preferably benzoxazolylnaphthalene-type and benzoxazolylstilbene-type brightening agents. Such a brightening agent has no particular restriction as to the amount used, but preferably it is added in an amount of 1 to 100 mg/m². When the brightening agent is mixed with a waterproof resin, its proportion to the waterproof resin is preferably from 0.0005 to 3 weight %, far preferably from 0.001 to 0.5 weight %. As the reflective support, it is also allowable to use a material prepared by coating a white pigment-containing hydrophilic colloid layer on a transparent support or a reflective support as recited above. In addition, the reflective support may be a support having a mirror-reflective or secondary diffuse reflective metallic surface.

The above paragraphs have described color photosensitive materials usable in the invention. Those descriptions of color photosensitive materials for picture-taking and printing uses, except the description of color development, also hold true in a substantial sense for positive black-and-white photosensitive materials for picture-taking and printing uses which are usable in the invention.

As printers for making prints by the photographic processing using the present granular processing agent(s), general-purpose printers can be used. In addition, the photographic processing using the present granular processing agents are not only applicable in print systems using general negative printers, but also suitable for the scanning exposure systems using cathode-ray tubes (CRT). CRT exposure devices are simple, compact and inexpensive, compared with laser-utilized devices. Further, it is easy for them to adjust their optical axes and colors. In cathode-ray tubes for imagewise exposure, various kinds of luminophors enabling light emission in spectral regions as required are used. More specifically, one of red luminophors, green luminophors and blue luminophors, or a mixture of two or more of them can be used therein. The spectral regions are not limited to the red, green and blue ones as mentioned above, but phosphors emitting yellow light, orange light, violet light or light in the infrared region may also be used. In many cases, cathode-ray tubes enabling emission of white light by using those luminophors in mixed states are employed.

In the case of using a photosensitive material having two or more light-sensitive layers differing in spectral sensitivity distribution and a cathode-ray tube having phosphors capable of emitting light in two or more different spectral regions, simultaneous exposure to lights of two or more different colors, or light emission from the tube surface by inputting image signals of two or more different colors into the cathode-ray tube, may be performed. Alternately, the method of inputting image signals of different colors sequentially into a cathode-ray tube to cause the tube to emit light of each color in succession and performing exposure to the thus emitted light through a film capable of cutting off colors other than the color of emitted light (sequential mask exposure) maybe adopted. In general, the sequential mask exposure is favorable for enhancement of image quality, because it permits the use of a high-resolution cathode-ray tube.

The photosensitive materials to which the invention is applicable are suitable for adoption of a digital scanning exposure system utilizing monochromatic high-intensity light from gas laser, light-emitting diode, semiconductor laser, or a second harmonic generation source (SHG) in which semiconductor laser or solid laser using semiconductor laser as an optically pumping source is combined with a nonlinear optical crystal. From the standpoint of rendering the system compact and inexpensive, it is advantageous to use semiconductor laser, or a second harmonic generation source (SHG) in which semiconductor laser or solid laser using semiconductor laser as an optically pumping source is combined with a nonlinear optical crystal. In order to design a compact, low-priced, long-life, highly stable device, the use of semiconductor laser is preferred in particular, and it is advisable to use semiconductor laser as at least one of exposure light sources.

When such scanning exposure light sources are used, the maximum spectral sensitization wavelengths of photosensitive materials used in the invention can be chosen depending on what wavelengths the scanning exposure light sources have. In the case of an SHG light source obtained by combining solid laser using semiconductor laser as optically pumping source or semiconductor laser with a nonlinear optical crystal, the lasing wavelength can be reduced to half, so that blue light and green light can be obtained. Therefore, it is possible to let the photosensitive materials have the spectral sensitivity maxima in the general three wavelength regions, namely blue, green and red regions. Defining the exposure time in such scanning exposure as the time required for exposing the area of one pixel size in the case of a pixel density of 400 dpi, the suitable scanning exposure time is 10⁻⁴ second or below, preferably 10⁻⁶ second or below. In addition, for the purpose of preventing unauthorized copies of photosensitive materials having undergone the processing relating to the invention, latent images with microdot patterns can be imparted to the photosensitive materials. The method for imparting such latent images to photosensitive materials can be found in JP-A-9-226227.

The scanning exposure systems applicable appropriately to the invention are disclosed in detail in the publications cited in the above table. For the processing of photosensitive materials to which the invention is applicable, the processing materials and methods disclosed in JP-A-2-207250, page 26, lower right column, line 1, to page 34, upper right column, line 9, and JP-A-4-97355, page 5, upper left column, line 17, to page 18, lower right column, line 20, can be used to advantage.

Now, the invention is illustrated in more detail by reference to the following examples, but these examples should not be construed as limiting the scope of the invention in any way.

### EXAMPLE 1

Granular solid processing agents were prepared using the following ingredients for bleach-fix processing in accordance with the method mentioned below.

Ingredients for Bleach-Fix Processin

| | | |
|---|---|---|
| Ingredient A: 7:3 (by mass) Mixture of ammonium | 2,400 | g |
| thiosulfate and sodium thiosulfate | | |
| Ingredient B: Sodium sulfite | 1,200 | g |
| Ingredient C: Disodium ethylenediaminetetra- | 100 | g |
| acetic acid | | |
| Ingredient D: Ammonium ethylenediaminetetra- | 1,000 | g |
| acetatoferrate (III) | | |
| Ingredient E: Succinic acid | 700 | g |

Granulated Matter 1

The ingredient A was formed into a granulated matter having indefinite shape and an average granule size of 1 mm by means of a compression granulator (roller compactor). Next, each of the ingredients B to E was ground to a powder having an average particle size of 20 μm or below by means of a commercially available hummer mill. Then, the granules of the ingredient A were used as core and the surfaces thereof were coated with the ingredient B while spraying thereon water as a binder by means of a centrifugal flow coating granulator. In a similar manner to the above, the ingredient C was further coated on the surface of the coating layer of the ingredient B. Likewise, the ingredient D was furthermore coated on the surface of the coating layer of the ingredient C. In addition, the ingredient E was coated on the surface of the coating layer of the ingredient D in the same manner as mentioned above. And these coating layers were dried. Thus, core-shell spherical granules having an average size of 3 mm were obtained and referred to as Granulated matter 1.

Granulated Matters 2 to 4

Granulated matters 2 to 4 were prepared in the same manner as Granulated matter 1, except that the organic acids shown in Table 1 were used respectively instead of the ingredient E in amounts equimolar with the ingredient E.

The granulated matter Samples 1 to 4 were each weighed out in a portion of 100 g and charged into a plastic bottle. These bottles were shaken at 250 rpm for 1 day by use of a Multishaker MMS-310 made by EYELA. Thereafter, the thus shaken matters were transferred into separate beakers, allowed to stand indoors for 60 days as they were held open under a temperature of 32° C. and a relative humidity of 85%, and examined for changes in granular form (consolidation). Next, each sample was dissolved in 5 liter of water, and remaining rates of the ingredients A and B susceptible to degradation were determined by high-performance liquid chromatography. The results obtained are shown in Table 1.

TABLE 1

| | | Critical Humidity | | | | | |
|---|---|---|---|---|---|---|---|
| | | (32° C.) | | | | | |
| | | | Ammonium | | | | |
| Granulated | | | Salt of | | | | |
| Matter | | Organic | organic | Resistance to | Remaining Rate (%) | | |
| Sample | Ingredient E | Acid | acid | Consolidation | Ingredient A | Ingredient B | note |
| Granulated | succinic acid | 86% | 68% | D-grade | 96 | 45 | comparison |
| matter 1 | | | | | | | |
| Granulated | benzoic acid | 87% | 87% | A-grade | 100 | 99 | invention |
| matter 2 | | | | | | | |
| Granulated | maleic acid | 84% | 80% | A-grade | 99 | 93 | invention |
| matter 3 | | | | | | | |
| Granulated | ethylenediaminetetraacetic | 87% | 78% | B-grade | 99 | 92 | invention |
| matter 4 | acid | | | | | | |

A-grade: No consolidation is caused.
B-grade: Light consolidation is caused, and flowability is recovered by delivering two mild shocks to the consolidated matter.
C-grade: Medium consolidation is caused, and flowability is recovered by delivering 10 strong shocks to the consolidated matter.
D-grade: Strong consolidation is caused, and flowability is not recovered even by delivering 10 strong shocks to the consolidated matter.

By comparisons performed between the comparative example using the granulated matter 1 and the present examples using the granulated matter 2, 3 and 4, it has been shown that the granular agents using benzoic acid, maleic acid and ethylenediaminetetraacetic acid, respectively, according to the invention, whose ammonium salts are greater than 70% in critical relative humidity, were prevented from consolidating even when allowed to stand for a long time under the high temperature-high humidity condition and the remaining rates of the ingredients A and B were kept at high levels.

### EXAMPLE 2

1. Method of Producing Color Paper

According to the description of Sample (001) in Example 4 of JP-A-2001-183779, a silver halide color photosensitive material (Sample No. 101) was prepared by subjecting a paper support coated with polyethylene resin on both sides to corona discharge treatment, then providing on the support surface a gelatin undercoat layer containing sodium dodecylbenzenesulfonate, and further coating the undercoat layer sequentially with first to seventh photographic constituent layers. Coating compositions for the individual photographic constituent layers were also prepared in the same manners as those for Sample (001) in Example 4 of JP-A-2001-183779.

2. Exposure and Processing Conditions for Color Paper

Photographs of persons standing in the middle-distant sunshiny outdoors were gotten on a commercially available color negative film, Fuji Color SUPERIA 400 (trade name, a product of Fuji Photo Film Co., Ltd.), and developed with an automatic developing machine, Model FP-363SC (trade name, made by Fuji Photo Film Co., Ltd.), using the color negative film processing formula CN-16S and its processing chemicals (trade name, made by Fuji Photo Film Co., Ltd.).

The image information of the developed color negative film was read with a mini-lab printer processor, Frontier 350 (trade name, made by Fuji Photo Film Co., Ltd.), and the Sample No. 101 was exposed by means of a laser exposure unit bearing the thus read image information and then subjected to continuous processing performed using the following processing solutions in accordance with the following processing steps until the development-conditions were in running equilibrium (the cumulative volume of the replenisher supplied to the developer became 3 times the developing tank volume).

Additionally, modifications were made to the tanks and the racks of Frontier 350 so that the processing was accomplished in the following processing steps, and besides, additional rotary feeder mode of replenishing apparatus was installed for adding a granular replenishing agent directly to a processing tank and additional replenishing apparatus for addition of water to a processing tank was also installed.

Additionally, the replenishing agent used in the color development was the granulated matter 8-granulated matter 7 (4:1 by mass) mixture disclosed in Example 1 of JP-A-2001-183779, and the replenishing agent used in bleach-fix processing was the Granulated matter 2 prepared in Example 1.

| | | | |
|---|---|---|---|
| Processing | Temper- | | Amounts replenished* |
| Step | ature | Time | (granular agent) water |

| Color | 45° C. | 12 | sec | 4 | g | 40 | ml |
|---|---|---|---|---|---|---|---|
| development | | | | | | | |
| Bleach-fix | 40° C. | 12 | sec | 8 | g | 28 | ml |
| Rinse 1** | 40° C. | 5 | sec | — | | | |
| Rinse 2** | 40° C. | 5 | sec | — | | | |
| Rinse 3** | 40° C. | 5 | sec | — | | | |
| Rinse 4** | 40° C. | 8 | sec | | | 175 | ml |
| Drying | 80° C. | 10 | sec | | | | |

*Replenisher volume was per m² of photosensitive material.
**In rinsing process, 4-stage countercurrent method from rinse 4 to rinse 1 was adopted.
***Overflows from individual steps were gathered together and stored in one tank as the waste solution. The composition of each processing solution is described below.

[Color Developer]

| | | |
|---|---|---|
| Cation exchange water | 800 | ml |
| Surfactant of dimethylpolysiloxane type | 0.1 | g |
| (Silicone KF351A, trade name, produced by | | |
| Shin-Etsu Chemical Co., Ltd.) | | |
| m-Carboxymethylbenzenesulfinic acid | 5.0 | g |
| Ethylenediaminetetraacetate | 4.0 | g |
| Potassium chloride | 10.0 | g |
| Potassium bromide | 0.04 | g |
| Sodium sulfite | 0.1 | g |
| Brightening agent Hakkol FWA-SF (trade | 4.0 | g |
| name, produced by Showa Chemical) | | |
| Sodium p-toluenesulfonate | 20.0 | g |
| Potassium carbonate | 27.0 | g |
| Disodium N,N-bis(sulfonatoethyl)hydroxylamine | 10.0 | g |
| N-Ethyl-N-(β-methanesulfonamidoethyl)-3-methyl- | 10.0 | g |
| 4-aminoaniline·3/2sulfate·monohydrate | | |
| Water to make | 1,000 | ml |
| pH (adjusted with potassium hydroxide | 10.30 | |
| and sulfuric acid at 25° C.) | | |

[Bleach-Fix Bath]

| | | |
|---|---|---|
| Water | 600 | ml |
| Ammonium thiosulfate (75%) | 108 | ml |
| Ammonium sulfite | 42.0 | g |
| Ammonium ethylenediaminetetraacetato- | 46.0 | g |
| ferrate(III) | | |
| Ethylenediaminetetraacetic acid | 5.0 | g |
| Succinic acid | 20.0 | g |
| Water to make | 1,000 | ml |
| pH (adjusted with nitric acid and | 5.50 | |
| aqueous ammonia at 25° C.) | | |

[Rinsing Bath]

| | | |
|---|---|---|
| Sodium chloroisocyanurate | 0.02 | g |
| Deionized water (conductivity: 5 μS/cm | 1,000 | ml |
| or below) | | |
| pH | 6.5 | |

<Result of Photographic Processing Test>

Throughout the entire period of the running test, the present granular replenishing agent developed no replenishment trouble, and good results were obtained.

The present solid processing agents for silver halide photosensitive materials, which are each formed into granules containing an organic acid whose ammonium salt is at least 70% RH in critical relative humidity, can inhibit consolidation among their respective constituent granules even when the granules sustain some damage by vibrations during transportation and handling or/and they are placed under high humidity conditions, and thereby can have improved keeping quality, and besides, they have no loss of processing agent quality, or no adverse effects on photographic properties. Especially when the invention is applied to processing agents having a fixing capability and the processing agents are formed into core-shell granules, excellent effects can be achieved.

The present application claims foreign priority based on Japanese Patent Application No. JP2003-55911, filed Mar. 3, 2003, the content of which is incorporated herein by reference.

What is claimed is:

1. A solid processing agent for a silver halide photosensitive material, which comprises granules comprising an organic acid, wherein an ammonium salt of the organic acid has a critical relative humidity of at least 70% RH.

2. The solid processing agent according to claim 1, which is used in a processing solution having a fixing capability.

3. The solid processing agent according to claim 1, wherein the granules have a core-shell structure comprising a core and at least one shell layer.

4. The solid processing agent according to claim 3, wherein the core comprises a thiosulfate.

5. The solid processing agent according to claim 1, wherein the critical relative humidity is a critical relative humidity at 32° C.

6. The solid processing agent according to claim 3, wherein at least one of the at least one shell layer contains the organic acid and the critical relative humidity is a critical relative humidity at 32° C.

7. The solid processing agent according to claim 5, wherein the organic acid is an acid selected from the group consisting of an alkylcarboxylic acid having 3 to 12carbon atoms, an alkylenedicarboxylic acid having 5 to 12 carbon atoms, an alkenylenedicarboxylic acid having 4 to 12 carbon atoms, a phenylenedicarboxylic acid, an aminopolycarboxylic acid and a phenylmonocarboxylic acid.

8. The solid processing agent according to claim 1, wherein the granules contains the organic acid in an amount of 2 to 50% by weight.

9. The solid processing agent according to claim 3, wherein the at least one shell layer contains the organic acid in an amount of 20 to 100% by weight.

10. The solid processing agent according to claim 1, which is used in a color developer.

11. The solid processing agent according to claim 1, wherein the granules have an average particle size of 0.5 to 20 mm.

12. A method of producing a granular solid processing agent for a silver halide photosensitive material, which comprises forming one of an organic acid and a mixture containing the organic acid into granules in a state that the organic acid or the mixture makes up all or a part of granules, wherein an ammonium salt of the organic acid has a critical relative humidity of at least 70% RH at 32° C.

13. The method of producing a granular solid processing agent according to claim 12, wherein the granule-formation comprises: forming a core having a critical relative humidity of 70% RH or lower at 32° C. by granulation; and forming at least one coating layer covering the core so that the granules has a core-shell structure, wherein at least one layer of said at least one coating layer contains an organic acid and an ammonium salt of the organic acid has a critical relative humidity of 70% RH or higher at 32° C.

14. The method of producing a granular solid processing agent according to claim 12, wherein an outermost layer of said at least one coating layer contains the organic acid.
